(19) United States
(12) Patent Application Publication
(10) Pub. No.: US 2003/0199347 A1
(43) Pub. Date: Oct. 23, 2003

(54) Differential drive system

(76) Inventor: W. Daniel Hillis, Encino, CA (US)

Correspondence Address: GLENN PATENT GROUP, 3475 EDISON WAY, SUITE L, MENLO PARK, CA, 94025, US

(21) Appl. No.: 10/128,960

(22) Filed: Apr. 23, 2002

(51) Int. Cl. F16H 7/00

(52) U.S. Cl. 474/68; 474/62; 474/59

(57) ABSTRACT

A drive system is provided comprising two rotatable drive members which have different effective mechanical advantages. The rotatable drive members are directionally linked or indexed in a one to one relationship. A drive link, such as a chain, band or belt, is connected to each of the drive members. The drive link is also linked to a source of potential energy, such as a drive weight or a drive spring. The drive members rotate upon movement of the drive link in reaction to the energy source. While the drive members rotate similarly through the one to one link, the drive link moves in relation to the difference in mechanical advantage between the rotatable drive members. The differential drive system can be used to provide a driving force for a connected device, such as a clock. In some embodiments, a secondary bias force, such as a bias weight, spring, or dampener, is used to take up slack and/or to provide tension for the drive link.

### FIELD OF THE INVENTION

The invention relates to the field of mechanical drive systems. More particularly, the invention relates to a drive system for driving a clock.

### BACKGROUND OF THE INVENTION

Drive systems in mechanical clocks typically often comprise one or more weights hung from an assembly comprising a large number of pulleys. The stored potential energy from the elevated weights provides a driving force for a clock mechanism, as the weights move downward in reaction to gravitational forces.

A conically wound pulley, such as a fusee, is often provided within large mechanical clocks, whereby the drive system provides an even amount of power as the system unwinds. A plurality of connecting gears typically provides a desirable driving speed for a connected clock mechanism.

While conventional drive mechanisms for large clocks provide operational power for the clock, a large number of connected gears, e.g. such as six or seven gears, are required to produce the slow speed typically required to drive a clock.

It would be advantageous to provide a drive system with a low number of connected drive gears, which provides system power for a connected mechanism, such as a low speed mechanically-driven clock. The development of such a drive system would constitute a technological advance.

As well, it would be advantageous to provide a drive system which provided mechanical power while minimizing system size, rotational inertia, and friction. The development of such a drive system would constitute a further major technological advance.

### SUMMARY OF THE INVENTION

A drive system is provided comprising two rotatable drive members, such as gears, sprockets, cogs, or pulleys, which have different effective mechanical advantages. The rotatable drive members are linked or indexed in a one-to-one relationship. A drive link, such as a chain, band or belt, is connected to each of the drive members. The drive link is also linked to a source of potential energy, such as a drive weight or a spring. The drive members rotate upon movement of the drive link in reaction to the energy source. While the drive members rotate equivalently through the one-to-one link, the drive system moves in relation to the difference in mechanical advantage between the rotatable drive members. The differential drive system can be used to provide a driving force for a connected device, such as a clock. In some embodiments, a secondary bias force, such as a bias weight, spring, or dampener, is used to take up slack and/or to provide tension for the drive link.

### BRIEF DESCRIPTION OF THE DRAWINGS

FIG. 1 is a schematic view of a differential drive system, which comprises chain and sprocket construction;

FIG. 2 is a perspective view of a differential drive system, which comprises chain and sprocket construction;

FIG. 3 is a partial detailed view of a differential drive system, which comprises chain and sprocket construction;

FIG. 4 is a schematic view of a differential drive system, which comprises meshed band and cog construction;

FIG. 5 is a partial view of a meshed band and drive cog;

FIG. 6 is a partial view of an alternate meshed band and drive cog;

FIG. 7 is a partial view of a meshed chain and toothed drive cog;

FIG. 8 is a partial cross-sectional view of a drive weight cog assembly;

FIG. 9 is a partial cross-sectional view of a drive weight slider assembly;

FIG. 10 is a partial cross-sectional view of a tension cog assembly;

FIG. 11 is a partial cross-sectional view of a tension slider assembly;

FIG. 12 is a schematic view of a differential hoist system in a first position;

FIG. 13 is a schematic view of a differential hoist system in a second position;

FIG. 14 is a schematic view of a differential hoist system in a third position;

FIG. 15 is a flow chart of a basic differential hoist process;

FIG. 16 is a schematic view of an gear driven one to one drive link;

FIG. 17 is a schematic view of an belt driven one to one drive link;

FIG. 18 is a schematic view of a drive spring assembly;

FIG. 19 is a partial schematic view of a drive circuit dampener; and

FIG. 20 is a partial schematic view of differential drive system connected to a clock.

### DETAILED DESCRIPTION OF PREFERRED EMBODIMENTS

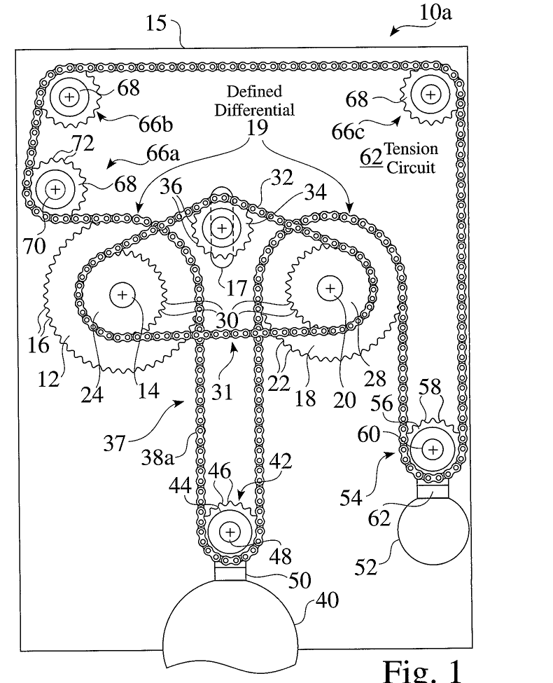

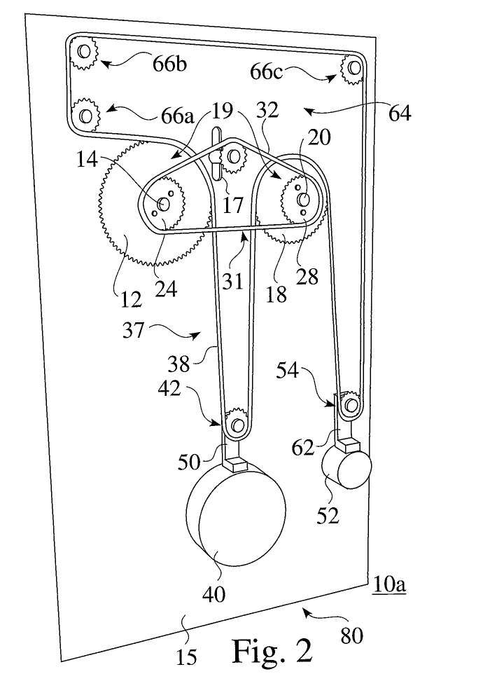

FIG. 1 is a schematic view of a differential drive system 10a, which comprises chain and sprocket construction. FIG. 2 and FIG. 3 respectively provide a perspective view 80 and a partial detailed view 90 of a differential drive system 10a, which comprises chain and sprocket construction. A first drive member 12 is rotatable about a first drive axis 14. A second drive member 18 is rotatable about a second drive axis 20. In the differential drive system 10a shown in FIG. 1, the first drive member 12 is a sprocket or cog 12, having engageable teeth 16, in which the teeth 16 engageably contact a drive chain 38. The second drive member 18 is similarly a sprocket or cog 18, having a engageable teeth 22, which the teeth 22 similarly engageably contact the drive chain 38.

While the first drive member 12 and the second drive member 18 are typically similar in construction, there is a difference in effective mechanical advantage 19 between them. For example, in one embodiment of a chain and sprocket differential drive system 10a, the first drive member 12 has seventy two gear teeth 16, while the second drive member 18 has seventy gear teeth 22, wherein the effective mechanical advantage is equivalent to the effective drive ratio 19, e.g. 72:70 (approximately 1.029).

As seen in FIG. 1, a drive link 37 typically comprises a drive chain 38, which is in engageable contact to both the first drive member 12 and the second drive member 18, and extends to a first main drive weight 40, which is suspended from the drive chain 38 by a weight assembly 42. A first weight suspension sprocket 44, shown in FIG. 1, may comprise engageable teeth 46, and is pivotable about an axial member 48. The first lower weight 40 is suspended from the axial member 48 by a weight bracket 50.

Similarly, the chain 38 in FIG. 1 is in preferably acted upon by a secondary, i.e. tension weight 52, which is suspended from the chain 38 by weight assembly 54. A second weight suspension sprocket 56, having engageable teeth 58, is pivotable about an axial member 60. The second lower weight 52 is suspended from the axial member 60 by a weight bracket 62.

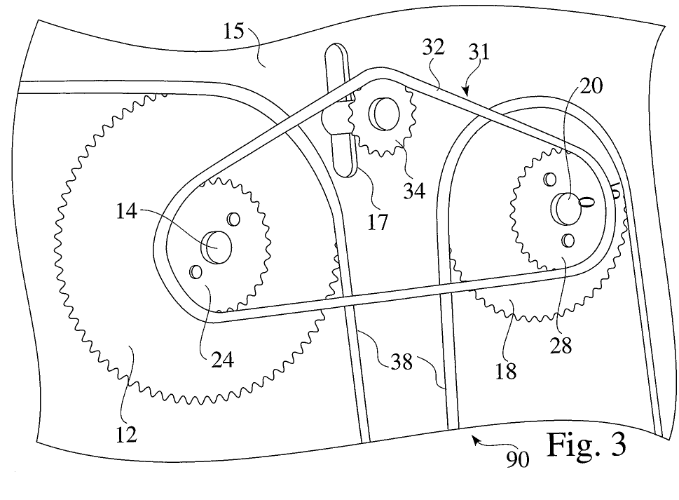

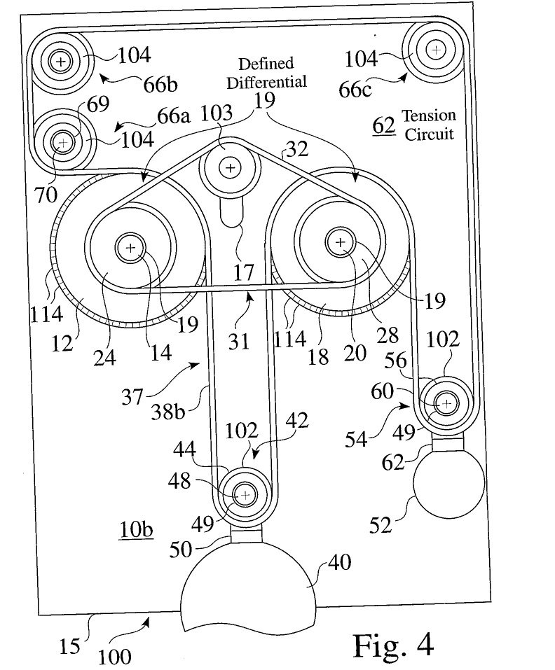

The second weight 52 acts as a portion of a tension circuit 62 for the drive link 37, such as for a chain 38a (FIG. 1) or a drive band 38b (FIG. 4). The second weight 52 acts in an opposing relation to the first drive weight 40. When the differential hoist system 10 is allowed to operate, the system generally moves in response to the force applied by the main drive weight 40, which is heavier than the secondary weight 52. The opposing relation of the second weight 52 provides an applied tension to the driving force provided by the main weight 40.

The differential hoist system 10 also comprises a one-to-one link 31 between the first drive member 12 and the second drive member 18, such that rotational movement of the first drive member 12 and the second drive member 18 is limited to the same direction and angle of rotation. In the exemplary one-to-one link 31 shown in FIG. 1, a first linking gear 24 having teeth 30 is fixedly attached to the first drive member 12, and similarly rotates about the first axis 14. A second linking gear 28 is fixedly attached to the second drive member 18, and similarly rotates about the second axis 20. A linking assembly 32, such as a linking chain 32, is located between the first linking gear 24 and the second linking gear 28 in the one-to-one link 31 shown in FIG. 1, a tensioner cog or slider 34, typically having teeth 36, is preferably included, which takes up slack in the linking chain 32. The rotatable tensioner cog 34 is typically attached to the base plate 15, such as through an adjustable slot 17.

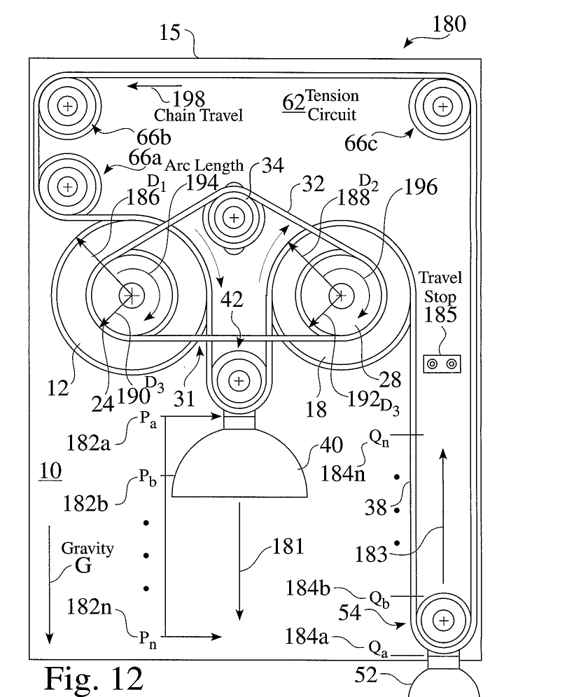

The differential hoist system 10 provides a suitable mechanism for a wide variety of driving purposes, such as for clocks. In differential hoist systems 10 for which the differential drive ratio approaches unity, the differential hoist system 10 can provide an extremely even and slow driving motion, such as through drive chain travel 198 (FIG. 12). An external system or mechanism, such as a clock 270 (FIG. 20), can be connected to the differential drive system 10 at a wide variety of locations, such as through the drive link 37, or to either of the drive members 12,18. In some system embodiments, a clock connection comprises a portion of the tension circuit 62, such as through one of the tension assemblies 66.

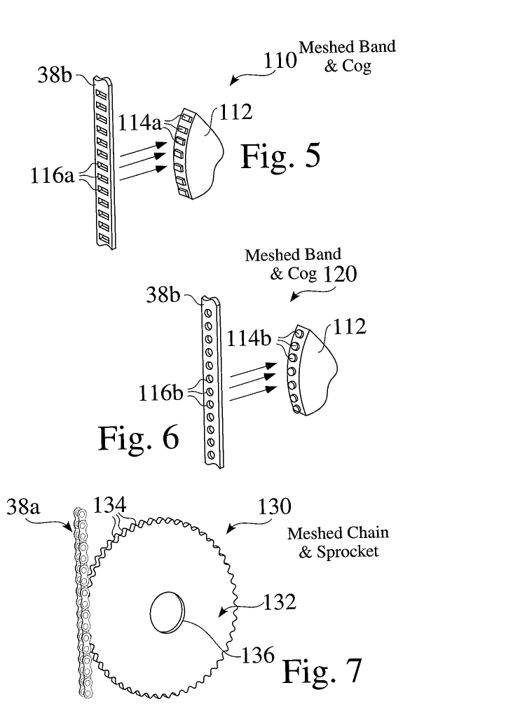

FIG. 4 is a schematic view 100 of an alternate differential drive system 10b, which comprises meshed band and cog construction. FIG. 5 is a partial view 110 of a meshed band and drive cog. FIG. 6 is a partial view 120 of an alternate meshed band and drive cog. FIG. 7 is a partial view 130 of a meshed chain 38a and toothed drive cog 132.

It is often preferable to reduce friction within the differential hoist system 10, such as by minimizing the quantity of moving components, and/or by minimizing the friction of the components. The differential system 10b seen in FIG. 4 provides a flexible and engageable drive tape 38b, which engageably contacts both the first drive gear 12 and the second drive gear 18. The drive tape 38b typically includes one or more engagement details 116, such as slots 116a (FIG. 5) or holes 116b (FIG. 6), which provide engagement to corresponding indexing details 114a,114b on drive gears 112, respectively, such as drive gear teeth 16,22 on the drive gears 12,18, as shown in FIG. 1. The drive tape 38b, typically comprising a flexible material, such as a polymer, rubber, or metallic spring material, provides a reduction in system friction for some embodiments of the differential hoist system 10, as compared to some chains 38a.

A variety of system configurations and component designs can be used to reduce friction further in differential hoist systems 10. For example, while some system embodiments use lubricated bearings 17,49,69, such as for drive axes 14,20, and or for tension circuit axes 70, in alternate system embodiments 10 comprise low friction bearings 17,49,69, such as unsealed, ungreased, grade 8 roller bearings 17,49,69.

As well, alternate configurations and component designs minimize rotational inertia in differential hoist systems 10. For example, the differential hoist system 10b shown in FIG. 4 provides drive circuit sliders 102, a link tension slider 103, and tension circuit sliders 104, which preferably comprise a low friction material, such as a fluoropolymer or Delrin™, and typically minimize the rotational weight of the system 10.

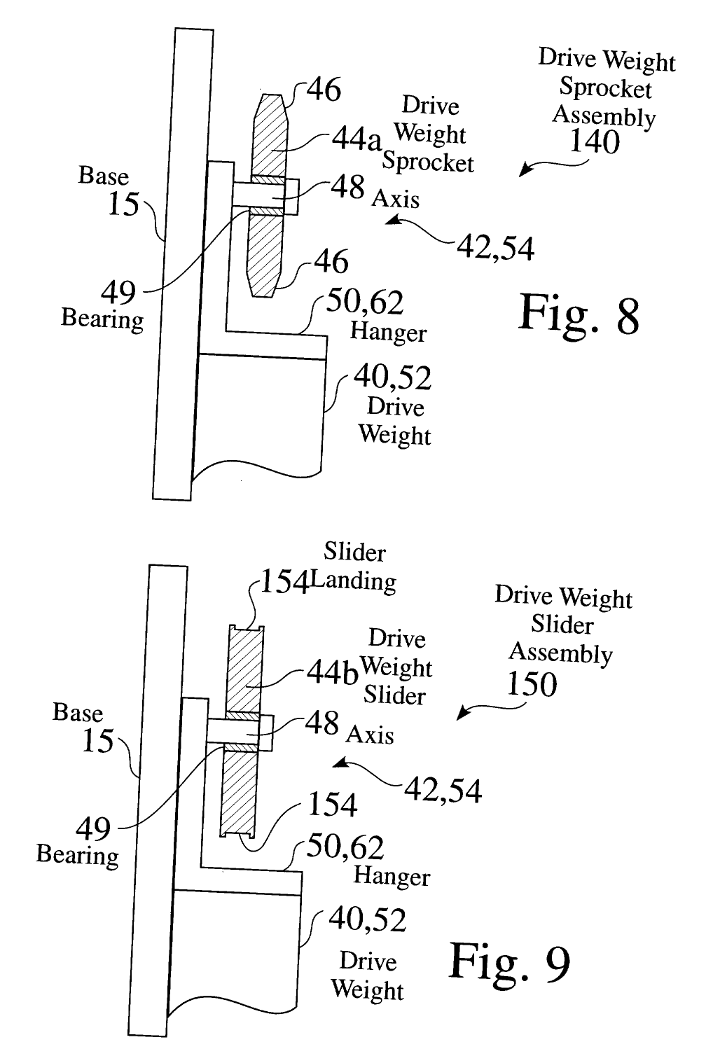

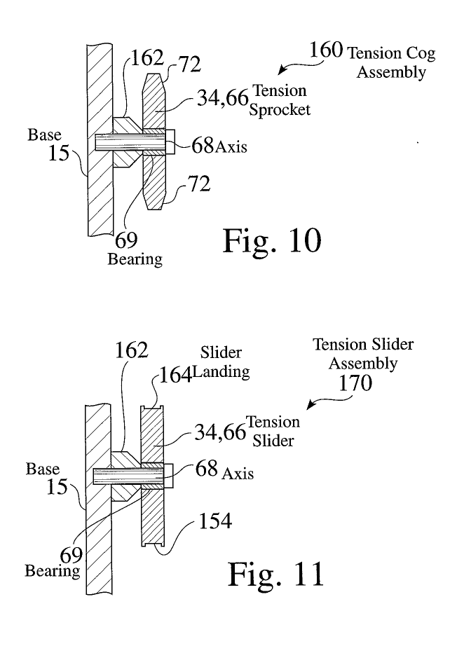

Various components in the drive circuit 37 and/or the tension circuit 31 utilize a variety of cogs or sliders to contact the either the drive chain or band 38 or the tension chain or band 32. FIG. 8 is a partial cross-sectional view 140 of a drive weight cog assembly 42,54. FIG. 9 is a partial cross-sectional view 150 of a drive weight slider assembly 42,54. FIG. 10 is a partial cross-sectional view 160 of a tension cog assembly 34,66. FIG. 11 is a partial cross-sectional view 170 of a tension slider assembly 34,66.

System Prototype. While a differential hoist system 10b comprising sliders 102,104 is preferable for some applications, a chain and sprocket differential hoist 10a, such as shown in FIG. 1, is readily fabricated, tested, and modified as desired.

A working differential hoist system 10a, having chains 32,38 and sprockets 12,18,24,28 was developed and tested. A variety of main drive sprockets 12,18 were used, providing different drive ratios 19. Wide needle bearings 17,69 were used in the working differential hoist system 10a, which provided single-bearing support for the drive sprockets 12,18, for the tension sprockets 66a-66c, and for the drive weight cogs 44,56.

In the working differential hoist system 10a, as seen in FIG. 12, each of the elements for the drive circuit 37 and for the linking circuit 31 are respectively coplanar. For example, in the linking circuit 31, the chain 32 is coplanar with the first linking gear 24, the second linking gear 28, and the tension cog or slider 34. Similarly, the drive chain 38 is coplanar with the first drive member 12, the second drive member 18, the drive assembly cogs or sliders 42,54, and tension cogs or sliders 68 within the tension circuit 62.

The base 15 shown in FIG. 1 further comprises a tension adjustment slot 17, which extends through the main plate 15, which allows adjustable positioning of a chain tensioner 34 between the linking gears 24,28, within the one-to-one link 31. A drive circuit stop 185 is also attached to the base, which provides a stop for drive circuit travel (FIG. 12-FIG. 14).

In one test configuration of the differential hoist system 10, the first drive gear 12 had 72 teeth 16, the second drive gear had 70 teeth, and each of the linking gears 24,28 had 18 teeth 36.

FIG. 12 is a schematic view 180 of an exemplary differential hoist system 10 in a first system resting position 182a, at a time tₐ, in which the main drive weight 40 is located at a first elevated position 182a, and the secondary weight 52, which is lighter than the main weight 40, is located at a first lower position 184a, providing system potential energy.

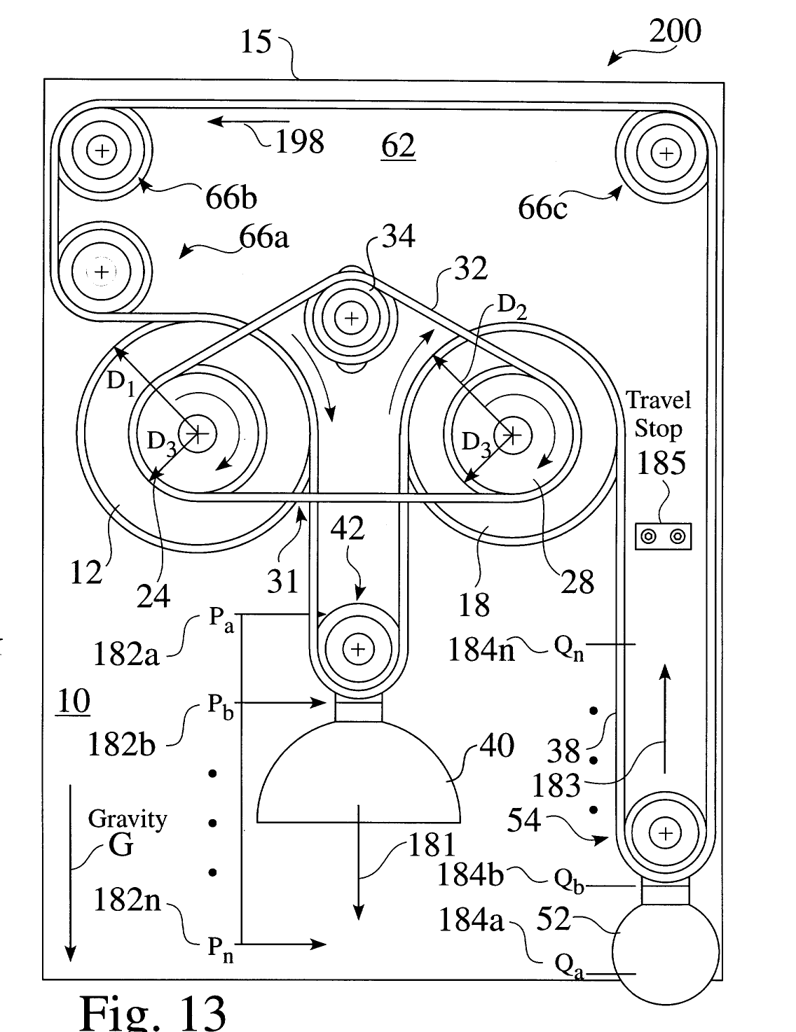

FIG. 13 is a schematic view 200 of the exemplary differential hoist system 10 in a second system position 182b, at a time t_{b}. FIG. 14 is a schematic view 210 of the differential hoist system 10 in a subsequent system position 182n, at a time tₙ, in which the system 10 is allowed to move further in response to gravity. When the system 10 is allowed to move in response to the system potential energy, such as from gravity, the main drive weight 40 moves downward 181 from the first elevated position 182a toward a second position 182b, and then toward a third subsequent position 182n. Similarly, the secondary weight 52 moves upward 183, from the first lower position 184a toward a second lower position 184b, and then toward a third subsequent position 184n, since the first weight 40 is heavier than the second weight 52.

The primary drive member 12 typically has an effective diameter D, 186, while the secondary drive member 18 typically has an effective diameter D₂ 188, in which the effective diameters 186,188 are not equal, i.e. the effective differential 19 does not equal unity.

As seen in FIG. 13 and FIG. 14, the main chain 38 generally moves in a direction corresponding to the larger gear, i.e. the first gear 12, since the first drive gear 12 is slightly larger than the other gear 18. As disclosed above, in one embodiment of the differential hoist, the first drive gear 12 has 72 teeth, while the second drive gear 18 has 12 teeth, providing a drive ratio of 72/70. Therefore, the first gear 12 has a “slight” mechanical advantage over the second drive gear 18.

In the differential hoist system 10 shown in FIG. 12, the effective diameter 186 of the first drive member 12 is larger than the effective diameter D₁ 186, while the secondary drive member 18. When the system is allowed to move, as the main weight 40 is lowered, the chain moves 189 in response to the effective differential 187, in a direction which is consistent with the mechanical advantage of the larger drive member 12.

As the main weight 40 moves downward, the chain 38 moves a greater distance 194, in relation to the first drive gear 12, which forces the drive chain 38 to travel 198 in the direction 194 of the larger gear 12. The secondary weight 52 and assembly 54 takes up slack for the differential hoist, and acts as a tensioner for the drive circuit 37.

As described above, the primary drive member 12 and the secondary drive member 18 are linked 31 in a one to one relationship, such as by respective link members 24,28, having equivalent effective link diameters 190,192, and a linking chain, band, or belt 32. The one-to-one link circuit 31 forces the secondary drive member 18 to move in the same direction, e.g. clockwise, as the primary drive member 12.

In one test configuration of the differential hoist system 10a, the initial system friction and rotational inertia initially prevented proper chain travel with a drive ratio 19 of 72:70. However, the exemplary test configuration of the differential hoist system 10a provided adequate chain travel when a 54 tooth gear was used for the second drive gear 18, i.e. providing a differential drive ratio 19 of 72:54, such that the main weight 40 traveled from a first position 182a the final position 182n, a distance of about 14 inches, in approximately 1 minute.

In alternate embodiments of the differential hoist system, which provide further reductions in system friction and rotational inertia, the differential drive ratio can be chosen to approach unity. In some system embodiments 10, metal tape 32, 38 is used to reduce friction the drive circuit 37 and/or the link circuit 31. In other system embodiments 10, the drive circuit 37 and/or the tension circuit 31 comprise a low number of moving parts, such as by removal of the upper tension sprocket 66b.

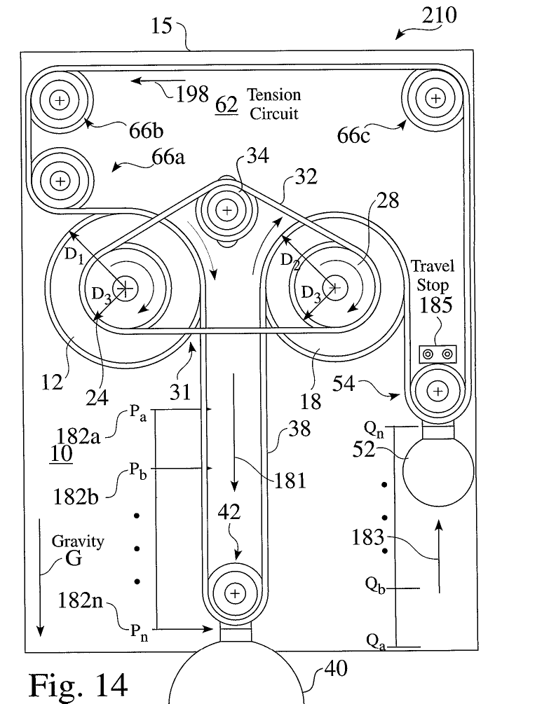

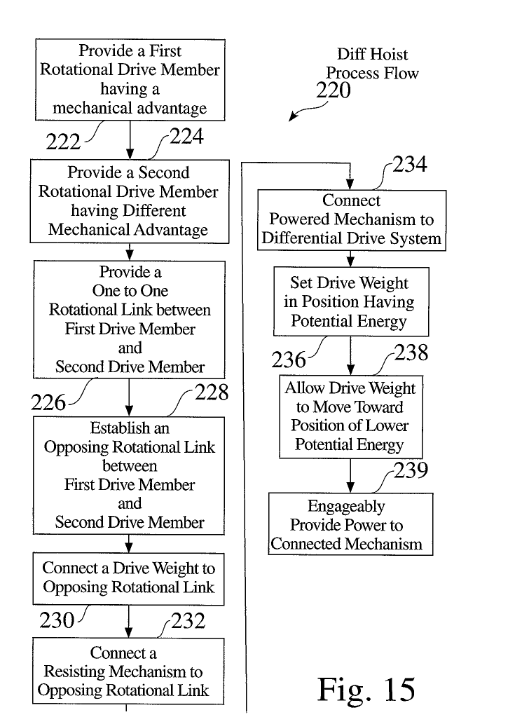

Differential Hoist Process. FIG. 15 is a flow chart of a basic differential hoist process 220, which comprises the steps of providing a first rotational drive member 12, at step 222, comprising a mechanical advantage, and providing a second rotational drive member 18, at step 224, comprising a mechanical advantage which is different that the mechanical advantage than the first drive member 12, i.e. defining a working drive ratio 19 which does not equal unity.

A one-to-one rotational link 31 is provided between the first drive member 12 and the second drive member 18, at step 226, which causes drive members 12,18 to rotate in unison, i.e. in the same rotational direction and defining the same rotational arc length.

An opposing rotational link 37 is also engageably connected to both the first drive member 12 and the second drive member 18, at step 228, typically comprising a chain belt or band 38, which travels in relation to the rotational direction of the drive members 12,18. A drive weight 40 or other source of potential energy is applied to the opposing rotational link 37, at step 230. A resisting mechanism, such as a secondary weight 52 or a connected mechanism 270, is connected to the opposing rotational link 37, at steps 232 and or 234.

The formed differential hoist 10 is then typically positioned, at step 236, such that the drive weight 40 is located in a position 182 having potential energy. When the system is allowed to move, the drive weight 238 moves toward a position of lower potential energy, at step 238, and the system 10 engageably provides power to a connected mechanism 270, at step 239. The differential hoist system 10 is typically resetable, such that the system 10 repeatably provides power for the connected mechanism 270.

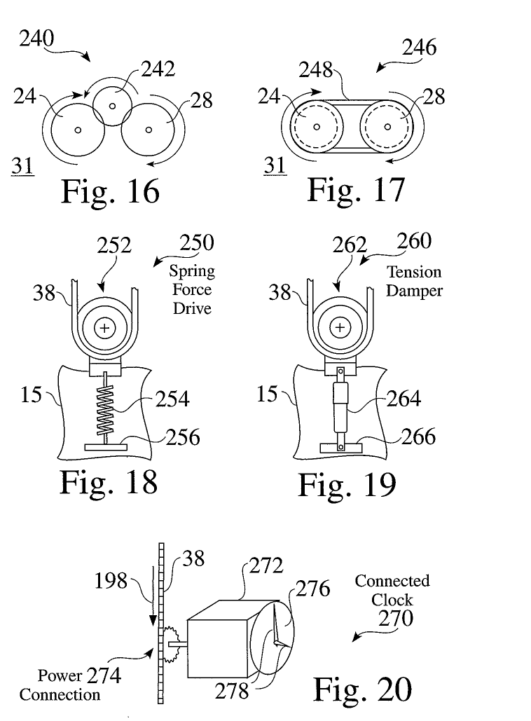

Alternate One-to-One Links between Drive Members. FIG. 16 is a schematic view 240 of a gear driven one-to-one drive link 31, in which an intermediate gear 242 provides an indexed connection between the first rotational drive member 24. FIG. 17 is a schematic view 246 of a belt driven one-to-one drive link 31, in which an intermediate band or belt 248 provides an indexed connection 31 between the first rotational drive member 24. The one-to-one link 31 is alternately provided by any mechanism or assembly 31 which equivalently provides a one-to-one relationship in rotation magnitude and in rotation direction, e.g. providing equivalent clockwise or counterclockwise rotation, between the first drive member 12 and the second drive member 18.

Alternate Drive Circuit Mechanisms. While the exemplary differential hoist systems 10 described above comprise weight assemblies 42,54 which typically comprise primary and secondary weights 40, 52, alternate embodiments of the drive circuit 37 may comprise a variety of driving, tension, and or dampening mechanisms.

While the exemplary driving mass assembly 42 and tension mass assembly 56 are generally described herein with respect to weights, the functionality of the driving mass assembly 42 and/or tension mass assembly 56 may readily be provided by other suitable driving forces. For example, a driving spring assembly 252 (FIG. 18) may provide a driving force in relation to the first drive member 12 and the second drive member 18. Similarly, a counter spring 252 (FIG. 18) or dampener 264 (FIG. 19) can provide resistance to the motion, as a substitute for the secondary weight assembly 54.

FIG. 18 is a schematic view 250 of a drive spring assembly 252, such as a primary drive assembly 42 or a secondary drive assembly 52. In embodiments of the drive circuit 37 which comprise a drive spring assembly 250 as a primary drive assembly 42, a spring 254 extends between the primary drive assembly 42 and a stationary spring attachment 256, and provides a relatively high level of potential energy when the primary drive assembly 42 is located in a first resting position 182a (FIG. 14). When the differential system is allowed to move, the restoring force of the spring 254 provides the primary driving force for the system 10.

In embodiments of the drive circuit 37 which comprise a drive spring assembly 250 as a secondary drive assembly 42, the spring 254 extends between the secondary drive assembly 52 and a stationary spring attachment 256, and provides an increasing level of tension as the secondary drive assembly 52 is moved 183 in response to movement of the drive circuit 37. When the differential system 10 is allowed to move, the restoring force of the spring 254 in a secondary drive assembly provides a tension force for the drive circuit 37.

FIG. 19 is a partial schematic view 260 of a drive circuit dampener assembly 262. In embodiments of the drive circuit 37 which comprise a drive circuit dampener assembly 262 as a secondary drive assembly 42, a dampener mechanism 264 extends between the secondary drive assembly 52 and a stationary dampener attachment 266. The dampener mechanism 264 provides a dampening action as the secondary drive assembly 52 is moved 183 in response to movement of the drive circuit 37.

When the differential system 10 is allowed to move, the dampener 264 in the secondary drive assembly 42 dampens the movement of the drive circuit 37, which is moved primarily in response to the combined system structure, i.e. the driving force of the primary drive assembly 42, the mechanical differential 19 between the two drive gears 12,18, and the one-to one link 31 between the primary gears 12,28.

FIG. 20 is a partial schematic view of differential drive system connected to a clock 270. A mechanism 270 to be powered can be connected 272 to the differential hoist system 10 at a variety of positions, such as to the drive circuit 37, through the drive link 38. In the exemplary clock 270 shown in FIG. 20, a clock mechanism 272 receives mechanical power from the power connection 274, such as through movement 198 of the drive link 38. The clock mechanism 272 uses the applied power to provide a time display 276, comprising clock hands 278 and a clock face 280.

System Advantages. The differential hoist system 10 provides system movement and operation for a variety of mechanisms 270, with a relatively low number of drive members 12,18. The mechanical advantage of the differential hoist system 10 is based upon the difference between the primary drive member 12 and the connected secondary drive member 18. The differential hoist system 10 therefore provides a very slow and controlled movement, which is inherently geared down by the two active gears 12,18, such that the system can be connected to drive an external system 270.

Alternate Differential Drive Systems. While the differential drive system 10 is generally described herein with respect to gear drives for time keeping systems, one skilled in the art will readily appreciate that the differential drive system 10 may be applied to other applications, such as for any mechanical system which requires a slow geared-down drive with low numbers of active gears.

For example, the differential system 10 may alternately be operated as an engageable brake, such as to slow down the movement of a relatively fast moving mechanism, e.g. such as but not limited to a rotating flywheel and clutch assembly. As the differential system 10 provides a significant mechanical advantage within a small form factor, the system 10 can readily be adapted to convert the kinetic energy of a moving mechanism to stored potential energy within the drive circuit 37.

While the working differential hoist system 10a comprises sprocket and chain construction and coplanar drive and linking circuits 37,31, alternate differential drive systems 10 are not necessarily limited to coplanar construction. For example, in an alternate differential system 10 comprising flexible drive and/or linking belts 37,31, a variety of non-planar circuit configurations are possible.

Although the invention is described herein with reference to the preferred embodiment, one skilled in the art will readily appreciate that other applications may be substituted for those set forth herein without departing from the spirit and scope of the present invention.

Although the differential drive system and its methods of use are described herein in connection with clock operation, such as for large mechanical clocks, e.g randfather clocks or clock towers, the apparatus and techniques can be implemented for a wide variety of propulsion devices and systems, or any combination thereof, as desired.

Accordingly, although the invention has been described in detail with reference to a particular preferred embodiment, persons possessing ordinary skill in the art to which this invention pertains will appreciate that various modifications and enhancements may be made without departing from the spirit and scope of the claims that follow.

What is claimed is:

1. An apparatus, comprising:
a first rotational element comprising a first effective diameter; and
a second rotational element comprising a second effective diameter different from the first effective diameter;
a linking mechanism between the first rotational element and the second rotational element which limits rotation of the first rotational element and the second rotational element to equivalent rotational motion and rotational direction;
an opposing rotational drive link between the first rotational drive member and the second rotational drive member; and
a driving element engageably connected through the opposing rotational drive link to the first effective diameter of the first rotational element and to the second effective diameter of the second rotational element;
wherein in a first position, the driving element is located in a first position having a first potential energy;
wherein in a second position, the weight is located in a second position having a second potential energy lower than the first potential energy of the first position, such that the first rotational element and the second rotational element rotate in response to different arc length defined between the first effective diameter of the first rotational element and the second effective diameter of the second rotational element.

2. The apparatus of claim 1, in which the driving element is a weight.

3. The apparatus of claim 1, in which the driving element is a spring.

4. The apparatus of claim 1, in which the second position is lower than the first position.

5. The apparatus of claim 1, in which the linking mechanism is a chain.

6. The apparatus of claim 1, in which the linking mechanism is a belt.

7. The apparatus of claim 1, in which the linking mechanism is a band.

8. The apparatus of claim 7, in which the linking band comprises metal.

9. The apparatus of claim 1, in which the opposing rotational drive link is a chain.

10. The apparatus of claim 1, in which the opposing rotational drive link is a belt.

11. The apparatus of claim 1, in which the opposing rotational drive link is a band.

12. The apparatus of claim 11, in which the opposing rotational band comprises metal.

13. A process, comprising the steps of:
providing a first rotational drive member having a mechanical advantage;
providing a second rotational drive member having a second mechanical advantage different from the first mechanical advantage;
providing a one-to-one rotational link between the first rotational drive member and the second rotational drive member, such that the first rotational drive member and the second rotational drive member are rotatable through the same direction and arc length;
establishing a drive circuit comprising an opposing rotational link between the first rotational drive member and the second rotational drive member; and
connecting an energy source to the opposing rotational link.

14. The process of claim 13, further comprising the step of:
connecting a resistance mechanism to the opposing rotational link.

15. The process of claim 13, in which the mechanical advantages of the first rotational drive member and the second rotational drive member comprise effective diameters.

16. The process of claim 13, in which the mechanical advantages of the first rotational drive member and the second rotational drive member comprise a plurality of cog teeth.

17. The process of claim 13, in which the connected energy source is a weight.

18. The process of claim 13, in which the connected energy source is a weight.

19. The process of claim 13, in which the one-to-one rotational link comprises:
a first link member having a mechanical advantage;
a second link member having a mechanical advantage equivalent to the mechanical advantage of the first link member; and
a mechanical link between the first link member and the second link member.

20. The process of claim 13, further comprising the step of:
connecting a powerable mechanism to the drive circuit.

21. The process of claim 20, in which the powerable mechanism is a clock.

22. The process of claim 13, further comprising the step of:
positioning the differential hoist such that the energy source is located in a position having potential energy.

23. The process of claim 13, further comprising the steps of:
positioning the differential hoist such that the energy source is located in a position having potential energy;
allowing the differential hoist to move such that the energy source is moves toward a position having lower potential energy; and
powering an external mechanism based upon movement of the energy source between the first position and the second position.
